(19) United States
(12) Patent Application Publication
(10) Pub. No.: US 2003/0050037 A1
(43) Pub. Date: Mar. 13, 2003

(54) In-home digital network and method of assigning wireless terminals to base stations

(76) Inventors: Andreas Goedicke, Aachen (DE); Guido Muesch, Linnich (DE); Heribert Baldus, Aachen (DE)

Correspondence Address: Michael E. Marion, U.S. Philips Corporation, 580 White Plains Road, Tarrytown, NY, 10591, US

(21) Appl. No.: 10/227,670

(22) Filed: Aug. 26, 2002

(30) Foreign Application Priority Data
Aug. 30, 2001 (DE) 10142392.6

(51) Int. Cl. H04M 11/00

(52) U.S. Cl. 455/403; 455/517

(57) ABSTRACT

The invention relates to a method and a device for dynamic assignment of mobile terminals (E1, En) to one of a plurality of base stations (B1, B2, Bm) in an in-home digital network. The method is characterized in that it is executed autonomously in distributed manner at each base station (B1, B2, Bm). To this end, the base stations measure the connection strengths between them and the terminals located in their range (E1, En) and communicate the measured values thus obtained in a broadcast to all the other base stations. All the base stations may then calculate the assignment of terminals to base stations on the basis of the global information obtained using a predetermined algorithm, for example involving assignment of the terminal to the greatest connection strength taking account of hysteresis and a threshold value. If the newly calculated assignment has changed relative to the existing assignment, a base station sends a handover command to all the base stations, which command then triggers the corresponding take-over action. By performing the method in distributed manner, a high level of fault tolerance is achieved, wherein the method used is at the same time relatively simple to implement.

The invention relates to a method of assigning wireless terminals in in-home digital networks, in which the connection strengths between the base stations and the terminals are measured and each terminal is assigned to just one base station as a function of these measured values and optionally of an already existing assignment.

The invention additionally relates to an in-home digital network having a plurality of base stations and a plurality of wireless terminals, wherein the base stations include:

a) a wireless communications unit for wireless communication between the base station and terminals;

b) a wired communications unit for wired communication among base stations;

c) a measuring unit for determining the connection strengths to the terminals located within the range of the base station.

Future in-home digital networks will typically consist of both a plurality of stationary appliances such as, for example ,television (TV), video recorder (VCR) or tuner and a plurality of mobile devices such as Personal Digital Assistants (PDA) or Web-Pads. While the network connection for stationary appliances is primarily cable-based, mobile devices are connected to the network wirelessly by means of a radio or infrared connection to so-called base stations. In the following, “base station” will be understood to mean both access points which simply offer a connection between the wired network and the mobile terminal and base stations in the narrower sense, which assume additional tasks, such as for instance data pre-processing. Permanent and simultaneous availability of all base stations is not absolutely necessary. In particular, the base stations themselves may merely be components of other appliances, which may be switched on or off at any time.

The mobile terminals are increasingly those which offer access to applications with high data rates, for example applications in the field of TV, video, mobile video conferencing, monitoring or high-end games. Such mobile terminals are designated below as “Personal Infotainment Assistants” (PIA).

In principle, it would be possible to effect connection of all mobile terminals to an in-home network via a single “centrally” positioned base station. In practice, however, this approach has the disadvantage that the transmitter power of this base station would have to be extremely high, in order to reach all the rooms in a house and to supply many different terminals with data at the same time. For this reason, it is preferable to arrange a plurality of base stations in spatially distributed manner in the network. At the same time, it must be ensured that a terminal is assigned at a given time to just one of these base stations, in order to allow correct, unambiguous communication between the terminal and the network. The assignment of terminals to base stations is achieved in this case dynamically as a function of the spatial position of the terminal and the resultant strength of the connection with the respective base station. If the location of a terminal is changed relative to the base stations, it may be that the assignment of this terminal changes, i.e. that it needs to be disconnected from an original base station and connected with a different base station, into the range of which the appliance has moved. Transfer of active data transmission between the network and the terminal from one base station to another is known by the term “handover”.

Methods of assigning mobile terminals to changing base stations are known from public telephone networks (GSM etc.) and wireless computer networks (IEEE 802.11). These methods are controlled from a central entity, which, in the case of GSM, is located in the network or, in the case of the standard IEEE 802.11, is located on the mobile terminal.

Against this background, it was an object of the present invention to provide a method of assigning wireless terminals to base stations in an in-home digital network which exhibits a high level of functional reliability and is relatively low-cost.

This object is achieved by a method having the features of claim 1 and an in-home digital network having the features of claim 10. Advantageous embodiments are contained in the dependent claims.

In the method of assigning wireless terminals to base stations in an in-home digital network, the connection strengths between the base stations and the terminals are measured and, as a function of the measured values thus obtained and, if present, of an already existing assignment between terminals and base stations, each terminal is assigned to just one base station. The assignment effects that subsequent data transfer between terminal and network is handled via the assigned base station. Characteristic of the method is the fact that all the base stations calculate the assignment independently of one another on the basis of the same information (i.e. the above-mentioned measured values and existing assignment) and using the same algorithm.

In the method, all the base stations thus regularly check the assignment criteria for all currently reachable wireless terminals. All the base stations then mutually independently reach up-to-date assignment decisions, the result of which is the same due to the use by all the base stations of identical information and an identical algorithm. The base stations then coordinate their decisions by means of a communications protocol. The advantage of this “distributed” assignment method consists in a high level of functional reliability with regard to base station failure. In the case of such a base station failure or disconnection, the remaining base stations automatically take over assignment to the wireless terminals affected, as far as radio technology fundamentally allows this. Furthermore, base stations added to the in-home network are automatically included in the overall distributed assignment procedure when they are brought into operation. By dispensing with a central control entity, the method is in a position to respond very flexibly to the failure of individual base stations and independently to effect adaptation.

In the context of the method, each base station preferably measures the connection strengths therefrom to all reachable wireless terminals and then communicates the measurement results obtained in this way to all the other base stations. In this way, it is ensured that all the base stations in the in-home network are informed firstly about the base stations that are ready for operation, secondly-about all the reachable terminals ready for operation and thirdly about the quality of the connections between the terminals and the base stations, so that they may execute the global assignment algorithm on the basis of this global information.

According to a further embodiment of the method, a base station is deemed not to be available or operational by the other base stations, if no new measurement results have been communicated by this base station for longer than a preset period. Such an absence of measurement results is thus understood as an indication that the relevant base station is no longer available, due to having been switched off, for example. The other base stations may take this into account when evaluating the assignment algorithm and are protected from working with out-of-date measurement results.

According to a preferred configuration of the assignment algorithm, a terminal is assigned thereby to a new base station if the strength of the connection to this new base station is better by a preset amount than the strength of the connection to the base station currently assigned to the terminal. For example, it may be required that the strength of the connection to the new base station be greater than the strength of the connection to the current base station by a preset factor or by a preset difference. Such an assignment has the advantage that it effects hysteresis, which prevents an unstable assignment wavering between two base stations in a case where a terminal is equally easy to reach from two base stations.

An assignment rule of the latter type may be extended to the effect that the terminal is only assigned to a new base station when the strength of the connection to the currently assigned base station drops below a preset threshold value. In this way, unnecessary assignment changes may be prevented if a terminal moves within the overlap area between two base stations but constantly remains well within range of one of the base stations.

In some cases, such as for instance in the event of the connection of a terminal, a situation arises in which the relevant terminal is not currently assigned to any of the base stations. In such a case, this terminal is preferably assigned to that base station to which said terminal exhibits the greatest connection strength. If there happen to be a plurality of base stations with such a maximum connection strength, one of these base stations may be arbitrarily selected on the basis of an additional unambiguous criterion, for instance that with the smallest individual identification number.

If, when evaluating the assignment algorithm, a base station has calculated that a particular terminal should be transferred from another base station to itself, it preferably sends a handover command to all base stations, wherein this handover command initiates transfer of the relevant terminal. In the handover command, the base station states which terminal is to be reassigned to which base station. On the basis of this information, all the base stations could update their assignment protocols, i.e. enter the relevant terminal as having been assigned to the new base station and disconnected from the old base station. That base station which is currently connected to the terminal initiates disconnection from this terminal upon receipt of the handover command. Furthermore, the base station which has emitted the handover command is simultaneously a receiver of the command emitted by itself. Upon receiving it, it responds by initiating takeover of the relevant terminal. By dispatching the handover command to that base station which has determined transfer of a terminal to itself, the occurrence of a plurality of competing handover commands is prevented. By synchronized execution of the handover command by all base stations including the transmitter itself, correct temporal handling of the handover is ensured.

According to a further development of the assignment method, assignment of a terminal to a base station is dependent on what loads, with regard to data transfer, are present at the base stations. In this way, it may be ensured that data transmission is distributed as evenly as possible between the different base stations, provided this is possible on the basis of the radio transmission conditions.

In the context of the above-explained method, audio and/or video signals which exhibit a high data rate are exchanged between the terminals and the base stations.

The invention additionally relates to an in-home digital network having a plurality of base stations and a plurality of wireless terminals, wherein each base station includes the following elements:

a) a wireless communications unit for wireless communication between the base station and terminals;

b) a wired communications unit for wired communication between base stations;

c) a measuring unit for determining the connection intensities at the terminals located within the range of the base station.

d) a memory for storing connection strengths and assignments between the base stations and the terminals;

e) a control unit for calculating assignment of the terminals to the base stations according to a method of the above-explained type.

In the in-home digital network described, each base station thus comprises a control unit which is designed to perform a specific assignment algorithm which is the same for all base stations. This assignment algorithm may access information stored in the memory of the base station about the connection strengths and assignments between all the base stations and all the terminals. The advantage of such an in-home network lies in the fact that it is robust in relation to the disconnection of individual base stations and may also respond flexibly to re-connection of base stations into the in-home network.

The invention will be further described with reference to examples of embodiments shown in the drawings, to which, however, the invention is not restricted. In the Figures:

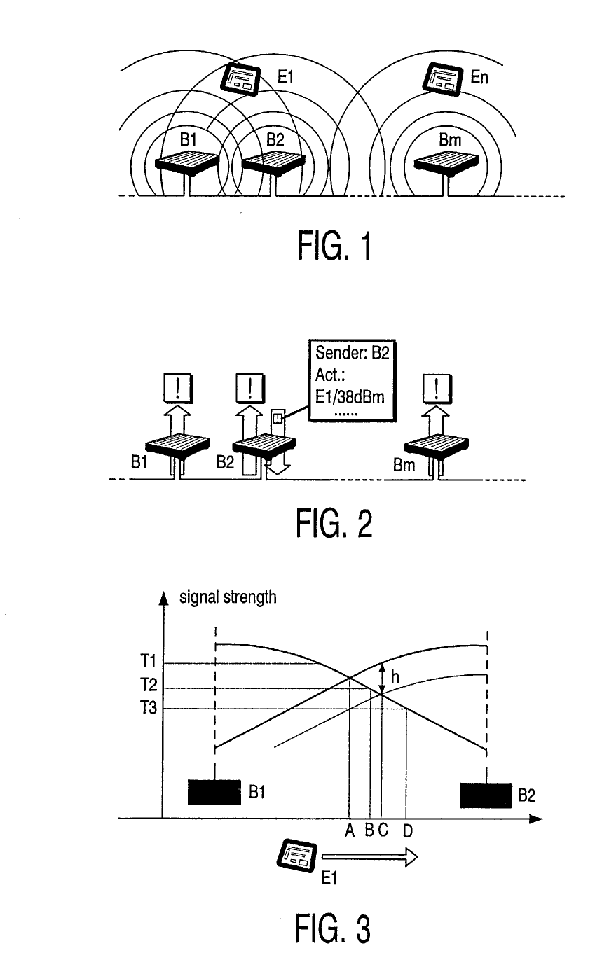

FIG. 1 is a schematic representation of a system consisting of a plurality of base stations of an in-home network and a plurality of mobile wireless terminals;

FIG. 2 is a schematic representation of the communication of data between the base stations of the in-home network;

FIG. 3 shows the connection strengths between a mobile terminal and two different base stations as a function of the position of the terminal;

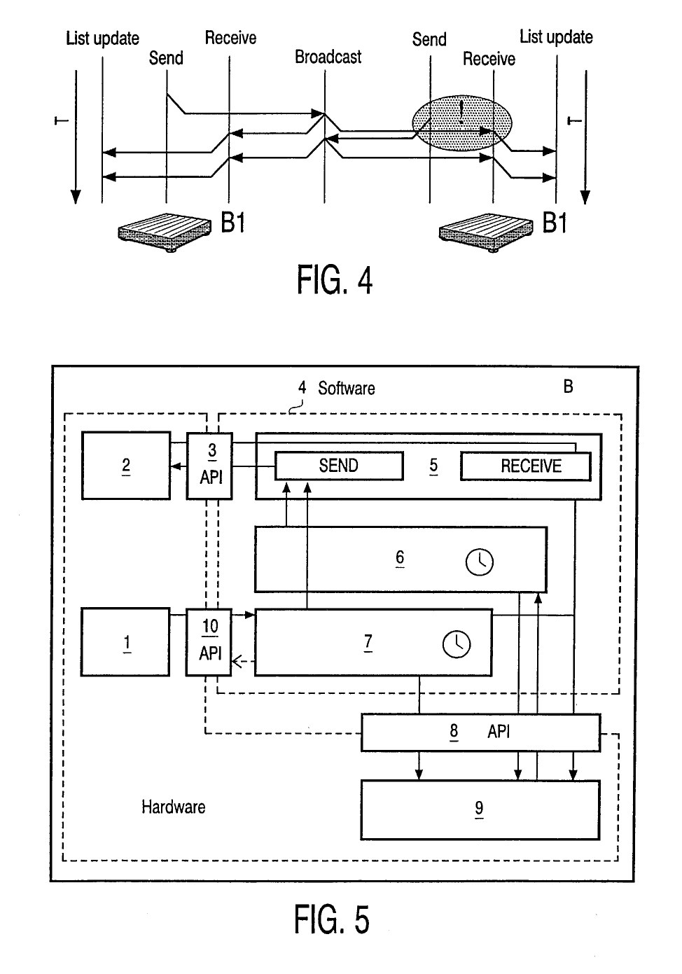

FIG. 4 is a timing diagram relating to a critical communications phase between two base stations;

FIG. 5 is a schematic representation of the components of a base station according to the invention.

The assignment method explained below for an in-home digital network is based on the following basic assumptions:

Due to the field of application in an in-home digital network (IHDN), the number of base stations and mobile terminals upon which it is based is relatively small.

The base stations are connected together in the IHDN by wiring, while the mobile terminals are connected to the base stations in wireless manner, for example by radio or infrared.

There is no designated central control unit (master) in the IHDN.

Base stations and mobile terminals or PIAs may be identified via permanent unique identifiers.

The connection between the base stations may be deemed interference-free or reliable in the sense that no messages are lost due to unnoticed connection breaks.

The connections between the base stations and the terminals cannot, on the other hand, be deemed reliable due to the nature of the wireless connection.

Both the number of active, operational base stations and the number of active, operational or reachable terminals may vary over time, due for example to failure of a base station or normal connection/disconnection of a terminal.

The device which produces the wireless connection between a local base station and terminals supplies information about the connection quality to all reachable terminals.

Handover execution is kept separate from the decision about assignment of terminals to base stations.

Starting from these assumptions, the aim is to provide an assignment algorithm and a handover procedure which guarantee dynamic assignment of terminals to base stations, in which each active terminal is assigned at all times to (in the case of a “soft handover” at least) one base station irrespective of its spatial position in the IHDN. In addition, it is intended to provide a dynamic response to the activation/deactivation of mobile terminals and to the appearance/disappearance of base stations. Finally, it is intended to provide information for other applications and services about the current assignment status, to allow these to re-route existing connections (streaming).

To achieve the stated objects, a method is proposed according to the invention for the assignment and handover of existing data transmissions which has the following basic features:

The method is executed in the base stations themselves, for example via appropriate software; i.e. apart from the devices present anyway, no additional device is required in the network.

A distributed algorithm is used to calculate the assignments; i.e. no special master base station is provided which decides for all the other base stations.

There is no central memory unit for the connection strengths measured by the base stations. Instead, the measurements are frequently broadcast around the base stations and stored locally.

FIG. 1 is a schematic representation of the components of an in-home digital network IHDN, which are affected by a handover. In the network, the base stations B1, B2, . . . Bm are connected together by wiring. The base stations are in wireless contact with mobile terminals E1, En. During the startup phase, the base stations B1, B2, . . . Bm produce a connection over a preset base station communications channel, which is provided by the wired network. Communication is effected in the manner of a broadcast, i.e. the messages sent on the broadcast channel are received by all the devices connected thereto.

In addition, the base stations B1, B2, . . . Bm frequently initiate a search for which of the mobile terminals E1, En are located within range thereof. If the terminal signal exceeds a lower threshold, e.g. −70 dBm, the unique identifier of the terminal and the detected signal level are stored in a local list of instantaneously active terminals. In FIG. 1, for example, the terminal E1 is arranged in the (overlapping) receive ranges of the base stations B1and B2, so that both base stations are entered in their local lists for this terminal E1.

If, at the end of the startup phase (see below), assignments exist between the base stations B1, B2, . . . Bm and the terminals E1, Em, movement of terminals may result in necessary handover processes. If, as described above, all reachable active terminals have been detected by one base station, e.g. the base station B2, this base station sends a message over the broadcast channel to all the other base stations. This procedure is shown schematically in FIG. 2. The send message contains information about the sender B2 and the detected terminals with their identifiers as well as the established connection strength. Since all the base stations listen to the broadcast channel, the sender B2 itself also receives its own communication, so that it may respond thereto just like all the other base stations.

When such a message has been received by a base station, the latter immediately updates its list of currently active terminals. In this way, this list contains global information about the state of the network with respect to all terminals. By means of the message sent by the base station B2, the base station Bm for example becomes aware of the mobile terminal E1, although the latter is not within range of Bm.

Furthermore, the information is also derived from the received messages about which base stations are present and operational. Since the messages about the connections illustrated in FIG. 2 are sent frequently, i.e. at preset intervals, each base station may check whether or not expected messages arrive within a preset period. Should no message from a given base station arrive for longer than a preset period, it is concluded therefrom that this base station is no longer operational.

On the basis of the locally available information, each base station B1, B2, . . . Bm repeats reassignment between the active terminals and the base stations. Assignment is preferably effected on the basis of the relative connection strength and hysteresis, as will be described below with reference to FIG. 3.

In the event of handover, i.e. the transfer of active data transmission between a terminal and a base station to another base station, a distinction may be drawn between a “hard handover” and a “soft handover”. A “hard handover” occurs when the old connection is broken off before a new one is activated. FIG. 3 is a schematic representation of the conditions constituting the basis of a handover. On the vertical axis, the connection strength between a mobile terminal E1 and a first base station B1or a second base station B2 is plotted against the spatial position (horizontal axis) of the terminal relative to the base stations. As the distance from the base station B1 increases, the connection strength between the terminal and said base station drops, while the connection strength of the second base station B2 increases at the same time due to increasing proximity.

Taking this situation as a basis, different assignment and handover scenarios have been developed and described in the literature. For example, in the simplest case the terminal E1 may be assigned to that base station exhibiting the greatest connection strength. In the event of movement from base station B1 to base station B2, the handover would occur at point A. In the region around point A, however, frequent unnecessary handover procedures could be initiated due to random signal strength fluctuations.

The method described may be extended in that the connection to the current base station is only relinquished when the associated connection strength drops below a preset threshold value AND the new base station exhibits a greater connection strength. If, as shown in FIG. 3, the threshold value is selected as T1, this method behaves exactly like the first-mentioned method. If the threshold value is fixed at T3<T1, on the other hand, it may be that the terminal E1 penetrates unnecessarily deeply into the transmission range of the second base station B2 before handover happens at point D. The selection of suitable threshold values is thus very problematic with this method.

According to another method, a handover may be effected with a hysteresis. This means that the change to the new base station B2 only occurs when the connection strength thereto is greater by a preset difference h than the connection strength to the current base station B1. This technique leads to a hysteresis and thus prevents the so-called “ping-pong effect” of repeated handover between two base stations where the connection strengths are identical.

In order, moreover, to prevent the base station from being changed unnecessarily, the hysteresis approach may be combined with the above-explained threshold value approach. In such a case, a handover is only effected when the connection strength to the current base station B1 drops below a preset threshold T2 and the connection strength to the new base station is greater than that to the old base station by the difference h. According to FIG. 3, using this method the change would take place at point C.

Handover algorithms are also known which base their decision on predictions about expected future connection strength values. In addition, the assignment algorithms may also take account of the loads at the respective base stations with connections to be maintained, in order to distribute the load over the network as evenly as possible. For further information about handover methods, reference is also made to the relevant literature (e.g. “Trends in Handover Design”, Gregory P. Pollini, IEEE Communications Magazine March 1996, pp. 82-90; M. Gudmundson, “Analysis of Handover Algorithms”, Proc. Vehicular Tech. Conf. 1991, St. Louis, Mo., May 19-22, 1991, pp. 537-542; V. Kapoor, G. Edwards, R. Sankar, “Handoff Criteria for Personal Communication Networks”, Proc. ICC 1994, New Orleans, La., May 1-5, 1994, pp. 1297-1301; R. Vijayan, J. M. Holtzman, “The Dynamic Behavior of Handoff Algorithms”, Proc. 1^{st} ICUPC '92, Dallas, Tex., paper 2.03, Sep. 29 -Oct. 2, 1992; R. Vijayan, J. M. Holtzman, “Analysis of Handover Algorithms Using Nonstationary Signal Strength Measurements”, Proc. Globecom '92, Orlando, Fla., paper 41.2, Dec. 6-9, 1992; G. E. Corazza, D. Giancristofaro, F. Santucci, “Characterization of Handover Initialization in Cellular Mobile Radio Networks”, Proc. Vehicular Tech. Conf. '94, Stockholm, Sweden, Jun. 8-10, 1994, pp. 1869-72; N. Zhang, J. M. Holtzman, “Analysis of Handoff Algorithms Using Both Absolute and Relative Measurements”, Proc. Vehicular Tech. Conf. '94, Stockholm, Sweden, Jun. 8-10, 1994, pp. 82-86; N. Zhang, J. M. Holtzman, “Analysis of a CDMA Soft Handoff Algorithm” Proc. PIMRC '95, Toronto, Canada, Sep. 27-29, 1995, pp. 819-823; G. N. Senarath D. Everitt, “Performance of Handover Priority and Queuing Systems under Different Handover Request Strategies for Microcellular Mobile Communication Systems”, Proc. Vehicular Tech. Conf. '95, Chicago, Ill., Jul. 25-28, 1995, pp. 897-901; D. Munoz-Rodriquez et al., “Neural Supported Hand Off Methodology in Micro Cellular Systems”, Proc. Vehicular Tech. Conf. '92, Denver, Colo., May 10-13, 1992, pp. 431-434; H. Maturino-Lozoya, D. Munoz-Rodriguez, H. Tawfik, “Pattern Recognition Techniques in Handoff and Service Area Determination”, Proc. Vehicular Tech. Conf. '94, Stockholm, Sweden, Jun. 8-10, 1994, pp. 96-100; G. Liodakis, P. Stravroulakis, “A Novel Approach in Handover Initiation for Microcellular Systems”, Proc. Vehicular Tech. Conf. '94, Stockholm, Sweden, Jun. 8-10, 1994, pp. 1820-1823; O. E. Kelly, V.V. Veeravalli, “A Locally Optimal Handoff Algorithm”, Proc. IEEE PIMRC '95, Toronto, Canada, Sep. 27-29, 1995, pp. 809-813; G. P. Pollini, “A Catalog of Handover Algorithms for the Cellular Packet Switch”, WINLAB Tech. Rep. TR-48, Rutgers, Jan. 1993).

As already mentioned, in the context of the present invention a handover is preferably used which uses both hysteresis and a threshold value. If, when such an assignment algorithm is executed, an assignment is determined for a base station which differs from the current (locally stored, tracked) assignment, a handover is initiated. The first base station which completes its assignment algorithm and has detected the need for a handover, sends a handover command on the broadcast channel to all the other base stations. Apart from this, however, no other direct activity is performed by the base station, not even when the transmitting base station is itself affected. It is also important for the base stations to be in a position merely to initiate handover of a terminal to themselves. This means that the base station may take over responsibility for a terminal, but is not in a position to relinquish assignment to a terminal by itself or to initiate handover of a terminal to another base station. Consequently, it is not necessary for the base station to re-check the assignment to terminals to which it has already been assigned.

The command or message signaling a handover contains the unique identifier of the mobile terminal and the identifier of the transmitting base station. If such a message is received by a base station, it responds immediately by updating its internal assignment list. In addition, mechanisms which are responsible for media-streaming, re-routing etc. are activated locally on the one hand at the previously assigned base station and on the other hand at the base station taking over the terminal. As a result of these local activities, the previously assigned base station stops transmission to the mobile terminal and the new base station begins its own transmission to the terminal.

Since in general a plurality of base stations checks the assignments autonomously and in parallel, it may happen that identical handover commands, which relate to the same terminal/base station pair, are sent in succession from different sources. The handover command may be received during three different phases. In these phases, the base station receiving the command may

1. not yet have begun its own assignment routine. In this case, the following local evaluation will confirm the executed assignment, since the data on which assignment is based are likewise locally present and the assignment approach is the same.

2. already have begun its own assignment routine, but not yet completed it. Since no handover decisions are made before the assignment calculation is fully complete, this does not constitute a critical situation either.

3. just have completed its own assignment routine and be beginning to send its own (most probably very similar) handover command before receiving the external one. This apparently problematic situation will be examined in more detail below with reference to FIG. 4.

FIG. 4 illustrates the situation using a message sequence diagram based on the assumption that the first base station B1 sends its message, followed by the second base station B2. It should be remembered that the base stations use the same medium for communication, i.e. the two messages cannot be sent at the same time, but rather only in succession. As has been mentioned above, neither the base station B1 nor the base station B2 effects any local activities on the basis of its handover calculation other than sending the handover command.

Once base station B1 has dispatched its message on the broadcast channel, both base stations B1, B2 receive this message and process it immediately. For this reason, it is ensured that the second message from base station B2, which is sent subsequently, is likewise subsequently processed at both local stations and that the assignment status is kept stable.

Another relevant aspect is handover synchronization. Since the handover command also serves as synchronization between the two switching events at the previous and newly assigned base station, the delay between them is minimized. In addition, consideration may be given to delaying the disconnection event by a fixed time, in order to guarantee that a soft handover is performed instead of a hard handover.

In summary, it may be noted that the distributed handover mechanism consists of three autonomous processes, which run at each base station:

collecting or measuring connection quality data from all active terminals within the local reception range and distributing these data using the broadcasting mechanism;

evaluating the locally available data, deriving an optimum base station/terminal assignment for the given point in time and initiating suitable handover activities by sending handover commands over the broadcasting mechanism;

executing local handover activities directly after receiving a handover command.

Implementation of the relative signal strengths with hysteresis (RSSH) approach will now be described in more detail with reference to pseudo code. As has already been described in the general explanation, a factor T>1 is initially selected therefor. In addition, the base stations at which the algorithm is executed require a table of the connection strength measurements between the currently operational terminals and the base stations together with a list of current assignments. In the stated list, some or even all the positions may be occupied by the entry “unknown”, if one or even several mobile terminals has/have been reactivated or if the base station itself has been restarted. Finally, a copy of this list is also needed as a new assignment list, in order to enter the results of the new calculation.

For each mobile terminal in this list for which the local base station is not the instantaneously assigned base station, the following steps are then performed:

1. IF the instantaneously assigned base station is known but is not operational

THEN search the table for the maximum connection strength measured for the terminal in question

IF the local base station is that which has the smallest identifier of all the base stations which exhibit the maximum connection strength, THEN select the local base station as the new assignment.

Skip the remaining steps and continue with the next terminal.

2. ELSE, IF the currently assigned base station is known and operational

IF the list contains base stations whose connection strength for the mobile terminal in question exceeds that of the currently assigned base station by more than the factor T (alternatively by an amount h)

THEN search the table for the maximum connection strength for the terminal in question

IF the local base station is that which has the smallest identifier among the base stations which exhibit the stated maximum, THEN select the local base station as the new assignment.

Skip the subsequent steps and continue with the next mobile terminal.

As mentioned above, the base stations are allowed only to initiate handover of a device to themselves. For this reason, the algorithm is only executed if the local base station is not already assigned to the terminal in question. Step 1 covers instances in which the previously assigned base station ceases to be operational. In this situation, it is attempted to assign the base station with the greatest connection strength to the terminal in question. If there is more than one candidate for this, the base station which has the smallest unique identifier is selected therefrom.

Step 2 relates to the instance in which either other base stations compete with the currently associated base station on the basis of the above-explained hysteresis approach or in which no other suitable candidates are currently available and, therefore, the original base station remains responsible for the terminal in question.

Closer examination of the algorithm described here shows that there are instances in which no assignment of a base station may be executed. This occurs principally if the earlier assignment status of a terminal is unknown. The reasons for such ignorance may be that

a new mobile terminal is attempting to effect connection to the in-home digital network;

the base station effecting assignment has just been re-started and therefore knows only the connection strength measurements but not any previous status.

It should also be noted at this point that the algorithm does not solve the problem of load distribution. In order to establish such functionality, it is necessary also to take account of the current load distribution when reassigning the base stations. This additional information may be easily incorporated into the messages already exchanged. On the basis of a local database containing all the current load statuses of all the base stations, the evaluating base station may select the candidates with the lowest load, if two or more base stations of similar suitability are present.

There follows a description of adaptation of the algorithm to the instance in which base stations or mobile terminals are newly connected with the in-home digital network. Both instances lead to the same situation: the base station does not know the current assignment either of one or indeed of any of the operational terminals.

First of all, reactivation of a mobile terminal will be examined. In this situation, there are instances in which a knowledge of the previously assigned base station is not required:

if there is only one base station, which has detected the terminal, such that there is no choice;

if there are at least two base stations which detect the terminal but the difference between the measured connection strengths is greater than the amount h, such that assignment may be effected unambiguously.

In order to avoid the necessity for distributing the assignment status frequently or to avoid an additional message type (such as an assignment request), a simple procedure for solving the above problem may be used: if the current assignment status of a mobile terminal is unknown, the hysteresis mechanism is deactivated. Instead, the best base station is simply assigned, i.e. the one with the best connection quality. If this situation results in more than one candidate, the base station that has the smallest identifier is again selected therefrom. Continuing with the above pseudo-code, this procedure would be described as follows:

3. ELSE

search the table for the maximum connection strength for the terminal in question

IF the local base station is that which has the smallest identifier among the base stations which exhibit the stated maximum, THEN select the local base station as the new assignment.

Continue with the next terminal.

As a consequence of this simple solution, the terminal is assigned to that base station (after a handover command) which is the first to “discover” the terminal in the course of its evaluation. This generates an entry for the terminal at the position of the currently assigned base station at each base station. As a result thereof, the hysteresis mechanism is re-activated. However, it may be that, due to a temporary absence of connection strength measurements, a base station tends to overreact and therefore causes an unnecessary handover in the startup phase. In order to provide a better basis for the local decision, therefore, at least one or two evaluate phases should be awaited, before the first handover activity is initiated.

Since reactivation of a base station is merely a generalization of an unknown terminal assignment to multiple (locally) unknown terminal assignments, the above-described simple procedure also covers this occurrence. It should be remembered that the assignment decision by a base station does not lead to direct local activity, even when the base station is itself affected. No hidden activity may therefore occur, since the base station has to initiate each handover activity by sending a handover command.

The frequent exchange of messages about connection strengths also allows checking of whether a base station is operating properly. Assuming that each base station has its own timer, a simple mechanism may be implemented for detecting whether or not the local data (connection strength measurements etc.) are still valid. If a message is received by a base station about connection status, the local time is stored together therewith (time stamp). When the evaluation phase is entered, it has then only to be checked whether the difference between the current time and the stored time stamp exceeds a predefined limit value. If this is the case, the base station is erased from the internal list of active appliances and the connection strength measurements are not taken into account during the subsequent evaluation.

In addition, consideration could be given to the fact that further activities are initiated to notify from other appliances connected with the in-home network of the change in status of the system. The same mechanism may also be used to monitor the mobile terminals. The difference here is merely that a more generous time limit value should be selected, due to the more unreliable connection between the base stations and the mobile terminals.

The proposed handover mechanism combines the advantages of error tolerance (due to the distributed approach) and simplicity, since communication between the stations and the assignment algorithm are simple. The most important features of the mechanism are as follows:

the locally measured connection quality data are frequently exchanged between the base stations via broadcast messages.

on the basis of their local assignment mechanisms, the base stations are only in a position to initiate handover of a terminal to themselves.

handover decisions are distributed over corresponding commands with broadcast messages.

local handover activities (local changes in assignment etc.) are always caused by a received handover command.

apart from the base stations present anyway, no further control means are necessary.

selection of a master base station is not necessary.

no central memory unit is required, since all the base stations store their data (connection strengths, current assignments) locally.

With reference to FIG. 5, the basic structure of a base station B according to the invention will now be described. An IHDN based on HAVi (Home Audio/Video Interoperability) will be considered as an example. With regard to hardware, the base station B comprises interface cards 1 and 2 to effect a connection to other base stations or to the mobile terminals. In addition, it includes a memory means 9 which may be permanent or volatile.

With regard to software illustrated in block 4, the base station comprises the following modules:

base station communications module 5, which comprises the sub-modules “SEND” and “RECEIVE”.

evaluation module 6;

connection quality detection module 7.

The software and hardware components are coupled together via application interfaces (API) 3, 10, 8.

In an example of embodiment, the hardware comprised personal computers with the operating systems Windows NT or Windows 98. The wired connection therebetween was effected by a 100 Mbps Ethernet. The wireless connection was provided by a product marketed under the WaveLAN (Turbo/Silver) trademark by Lucent Technology, which provides an 11 Mbps wireless connection according to IEEE Standard 802.11 b. The mobile terminal comprised the Stylistic LT made by Fujitsu.

For reasons of platform-independence, the software routines relating to handover were written wholly in JAVA (Version 1.2.2). The software was additionally subdivided into a local database and a handover mechanism (including communication between base stations, the evaluator 6 and the connection quality detector 7).

The local database should, in the present context, be understood to mean the minimum functionality required for storing and optionally pre-processing handover-related data to a base station. A database category with the name “Connection table” was implemented. The following information has to be processed locally and therefore also stored:

time stamp for base station messages

time stamp for mobile terminal messages

results of connection strength measurements

connection statuses

assignments between terminals and base stations.

Internal data structures have to be implemented which represent these data types. The number of data elements within these structures was constant and defined identically for all base stations. As a consequence, only one preset maximum number of base stations and/or mobile terminals may be connected with the IHDN, wherein the upper limit value depends for example on the number of available appliance addresses. The limit values and other handover-related constants may for example be loaded from a fixed location within the network environment, such that adaptation by changing the central parameters is possible.

As shown in FIG. 5, various software modules try to read from the database in the memory 9: the receive module 5, the connection quality detection module 7 and the evaluation module 6. As will be described further below, the last two modules are initiated by an internal scheduling mechanism, which is symbolized in the Figure by a clock, while the first module is triggered by the external occurrence of an incoming base station command or a connection status message. It must be ensured that their possibly parallel attempt to read and/or write data does not lead to any access conflict. The JAVA synchronization mechanism ensures that this may guaranteed.

Within the database category, various pre-processing routines are implemented:

a routine for calculating the running average value of the signal strengths last entered, since field strength measurements have to be time-averaged in order to compensate for fluctuations caused by the multi-path nature of the wireless connection.

a routine for inquiring whether or not the last signal was received by a particular mobile terminal within a preset time window.

a routine for inquiring whether or not the last signal was received by a particular base station within a preset time window.

a function which checks whether the local base station exceeds the threshold value for a given mobile terminal in comparison with the currently assigned base station.

a function which checks whether the local base station has measured the best signal strength for a given mobile terminal.

The three modules comprising base station communication 5, evaluation 6 and connection quality detection 7 were combined in a handover mechanism. Between these modules are four main data streams:

data coming in over the broadcast channel (handover commands and connection strength messages), which are handled by the receiver of the base station communications module 5, are forwarded directly to the local database.

data sent from the evaluator 6 to the broadcast channel (handover commands and connection strength messages).

data relating to the locally measured connection status results, which are handled by the connection quality detection module 7. These data are forwarded both to the sender unit of the module 5 and to the local database.

data from the database to the evaluation unit 6.

The broken-line arrows in FIG. 5 symbolize inquiry commands to the corresponding subunits. The clocks in FIG. 5 symbolize that the corresponding subunits are frequently triggered by an (external) scheduling mechanism.

Communication between the base stations (module 5) in the example was based on the Ethernet, as mentioned. However, it could also be based on HAVi/IEEE 1394.

The evaluation algorithm in module 6 was implemented as described above. Since it has to be executed frequently, an additional timer had to be implemented, which calls the mechanism after preset periods since its last execution, e.g. every 2.1 seconds.

The following table shows a graphic representation of the current connection status in the in-home network. The first line of the status illustrated as a table or matrix lists the instantaneously active base stations. In the case in question, only three stations are involved, which are shown by a simple index. The index may in particular be a placeholder for a standard identifier (e.g. IP address 192.168.20.4). That base station at which the software is currently being run is distinguished by a superscript asterisk. In the illustrated table this is consequently the base station with the index 2.

Likewise, the first column of the table shows which mobile terminals are instantaneously active in the network. If a base station has sent valid data via its connection to a mobile terminal, a plus sign is entered at the point where the line representing the terminal and the column representing the base station intersect. If it is known locally which base station is instantaneously assigned to the terminal, a master symbol “M” is entered at the appropriate point. In the example on which the table is based, the mobile terminal with the index 0 is thus received by all three base stations, wherein the base station with the index 1 is instantaneously assigned to the terminal.

| | Base stations | | | |
|---|---|---|---|---|
| PIA | 0 | 1 | 2* | − |
| 0 | + | M | + | − |
| − | − | − | − | − |

1. A method of assigning wireless terminals (E1, En) to base stations (B, B1, B2, Bm) in in-home digital networks, in which the connection strengths between the base stations and the terminals are measured and each terminal is assigned to just one base station as a function of the measured values thus obtained and, if present, of an already existing assignment between terminals and base stations, characterized in that all base stations calculate the assignment independently of one another on the basis of the same information and using the same algorithm.

2. A method as claimed in claim 1, characterized in that each base station (B, B1, B2, Bm) measures the relevant connection strengths and communicates the measurement results to all the base stations.

3. A method as claimed in claim 2, characterized in that a base station (B, B1, B2, Bm) is deemed unavailable if no new measurement results have been communicated thereby for longer than a preset period.

4. A method as claimed in at least one of claims 1 to 3, characterized in that a terminal (E1, En) is assigned to a new base station (B, B1, B2, Bm) if the strength of the connection to this new base station is better by a preset amount (h) than the strength of the connection to the currently assigned base station.

5. A method as claimed in claim 4, characterized in that the terminal (E1, En) is only assigned to the new base station (B, B1, B2, Bm) if the strength of the connection to the currently assigned base station drops below a preset threshold value (T₁, T₂, T₃).

6. A method as claimed in at least one of claims 1 to 5, characterized in that a terminal (E1, En), which is currently not assigned to any base station (B, B1, B2, Bm), is assigned to that base station to which the connection strength is greatest.

7. A method as claimed in at least one of claims 1 to 6, characterized in that a base station (B, B1, B2, Bm), which has calculated that a terminal (E, En) should be transferred from another base station to itself, sends a handover command to all base stations, which command initiates transfer of the relevant terminal.

8. A method as claimed in at least one of claims 1 to 7, characterized in that audio and/or video signals are exchanged between the terminals (E1, En) and the base stations (B, B1, B2, Bm).

9. An in-home digital network having a plurality of base stations (B, B1, B2, Bm) and a plurality of wireless terminals (E, En), wherein the base stations include:
a) a wireless communications unit (1) for wireless communication between the base station and terminals;
b) a wired communications unit (2) for wired communication between base stations;
c) a measuring unit (7) for determining the connection intensities at the terminals located within the range of the base station, characterized in that the base stations further include:
d) a memory (9) for storing connection strengths and assignments between the base stations and the terminals;
e) a control unit (6) for calculating assignment of the terminals to the base stations according to a method as claimed in at least one of claims 1 to 9.
